(19) United States
(12) Patent Application Publication
(10) Pub. No.: US 2017/0147954 A1
(43) Pub. Date: May 25, 2017

(54) PREDICATING PROJECT RELIABILITY, RISK, AND VARIATION BY USING EXPONENTIAL DISTRIBUTION

(71) Applicant: JIN XING XIAO, San Diego, CA (US)

(72) Inventor: JIN XING XIAO, San Diego, CA (US)

(21) Appl. No.: 14/948,363

(22) Filed: Nov. 22, 2015

(51) Int. Cl. G06Q 10/06; G06Q 10/10

(52) U.S. Cl. CPC G06Q 10/06313; G06Q 10/101

(57) ABSTRACT

Disclosed are methods for using exponential distribution function to predict project reliability and project risk at a project task level. Based on a project serial model assumption, project reliability and project risk can additionally be predicted at a phase level and at a final project level. The disclosed methods can also be used for predicting project schedule risk, project budget risk, and project supply chain risk. In addition, the disclosed methods provide an exponential distribution function for predicating project variations at a project task level. Based on a project serial model assumption, the disclosed methods can be used to predict project variations at a phase level as well as a final project level. The disclosed methods can also be used to predicting project schedule delays, project budget overages, and project supply chain part delays.

### BACKGROUND

Product development software and systems are used by project managers to schedule and track the completion times of tasks involved in developing a product. The systems may also be used to estimate chance of project budget completion within budget and chance of supply chain part on-time delivery in the product development process.

### SUMMARY

U.S. patent application Ser. No. 14/075,947, the contents of which are hereby incorporated by reference, discloses a “Risk Driven Product Development Process System” (RPDP). The RPDP is a product development framework that aligns with the regulatory requirements, such as those promulgated by the FDA, EU, and ISO 14835. The RPDP includes four major phases: product plan, product design, process development, and product launch. The four major phases include a total of 13 phases: business case, market requirement, design input, design, design output, design verification, design validation, design transfer, process development, process validation, process transfer, manufacturing, product service. The major phases and phases of the RPDP are illustrated in FIG. 1.

The RPDP model analyzes project risk and reliability by using a top-to-bottom approach. For example, at the project level, a product development consists of multiple phases and the success of a new product development project depends on the success of each phase, also known as a “serial model”. Project reliability in a serial model is expressed as follows:

$$\begin{matrix}Formula 1 \text{:} Project reliability model on system level & \\ {R}_{Project} = {\prod }_{i = 1}^{k} {R}_{i} & ( 1 )\end{matrix}$$

i: Development phase (i=1, k)
k: Number of development phases (e.g., 13)
Rᵢ: Reliability of phase i
R_{Project}: Reliability of entire new product development

U.S. patent application Ser. No. 14/797,147, the contents of which are hereby incorporated by reference, discloses a real-time risk driven product development management system (RDPDM) and its project deliverable map. In this application, a development phase consists of basic development tasks, as shown in FIG. 2.

At the project development phase level, a product development phase may consist of multiple tasks, and the success of the development phase depends on the success of each task, and is expressed as follows:

$$\begin{matrix}Formula 2 \text{:} Project reliability model on phase level & \\ {R}_{i} = {\prod }_{j = 1}^{k} {R}^{j} & ( 2 )\end{matrix}$$

j: Development task (j=1, k)
k: Number of tasks within phase i
R^{j}: Reliability of task j
Rᵢ: Reliability of development phase i

What is needed is a model for predicting project risk and reliability, as well as project variations (delay days, budget overages) at the task. Disclosed is a method, system, and computer software for predicting these risks and variations using an exponential distribution. In combination with Formula 1 and Formula 2, above, the disclosed methodology can be used to predict project reliability, project risk, and project variation at all levels of project task, project phase, as well as the entire project. The disclosed methodology can also be applied for predicting project schedule risk, project budget risk, and project supply chain risk.

### BRIEF DESCRIPTION OF THE DRAWINGS

A more complete understanding of the present inventions may be derived by referring to the detailed description and claims when considered in connection with the Figures, where like reference numbers refer to similar elements throughout the Figures, and:

FIG. 1 is an overview of a product development process which is used for breaking down a project risk/reliability from the entire project level into the phase level;

FIG. 2 is an overview of product development phase which is used for breaking down a project risk/reliability from the project phase level into the task level;

FIG. 3 demonstrates a project reliability prediction by using exponential distribution for calculating project risk/reliability on the task level.

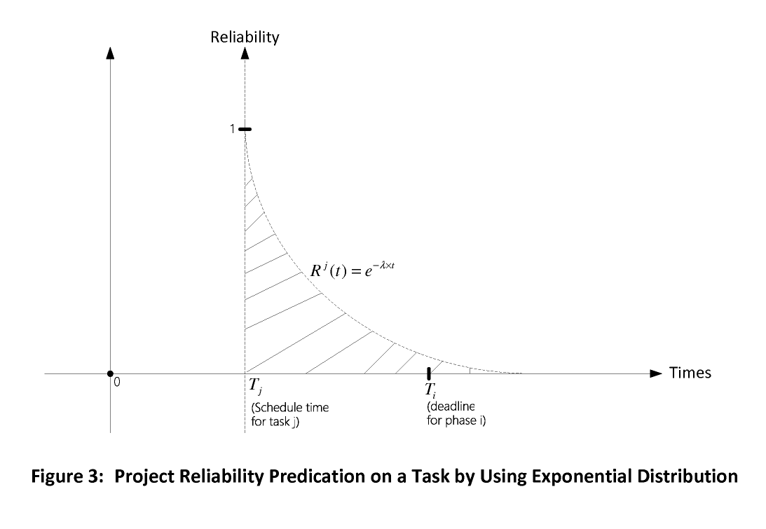

FIG. 4 is a flow chart illustrating the steps of a method of predicting project schedule reliability and/or risk in accordance with the disclosure.

FIG. 5 is a flow chart illustrating the steps of a method of predicting project budget reliability and/or risk in accordance with the disclosure.

FIG. 6 is a flow chart illustrating the steps of a method of predicting chance of part on-time delivery and potential delays in accordance with the disclosure.

FIG. 7 illustrates an exemplary computer system configuration in accordance with disclosure.

### DETAILED DESCRIPTION

Disclosed is a method, system, and computer-readable medium of instructions for predicting project schedule risk, budget risk, and supply chain risk using an exponential distribution. Another aspect of the disclosure is a method for predicting project schedule delays, over budgets, and supply chain part delays using an exponential distribution.

The embodiments or methodologies discussed throughout the disclosure may include various steps, which may be embodied in machine-executable instructions to be executed by a computer system. The computer system may comprise one or more general-purpose or special-purpose computers (or other electronic devices). Alternatively, the computer system may comprise hardware components that include specific logic for performing the steps or comprise a combination of hardware, software, and/or firmware. Without limitation, a computer system may comprise a workstation, desktop computer, laptop computer, disconnectable mobile computer, server, mainframe, cluster, so-called “network computer” or “thin client,” tablet, smartphone, multimedia device, electronic reader, personal digital assistant or other hand-held computing device, “smart” consumer electronics device or appliance, or a combination thereof. A server may include a physical server, a server cluster, a distributed server, a virtual server, a cloud server, a computer providing resources to one or more clients, a combination of one or more of the aforementioned, and/or the like. Some or all of the functions, steps, and/or operations discussed herein may be performed by one or more clients and/or one or more servers.

Those of skill in the art will realize possible divisions of operations between the one or more servers and the one or more clients. The following discussion describes a method for predicting project reliability and risk at the project task level.

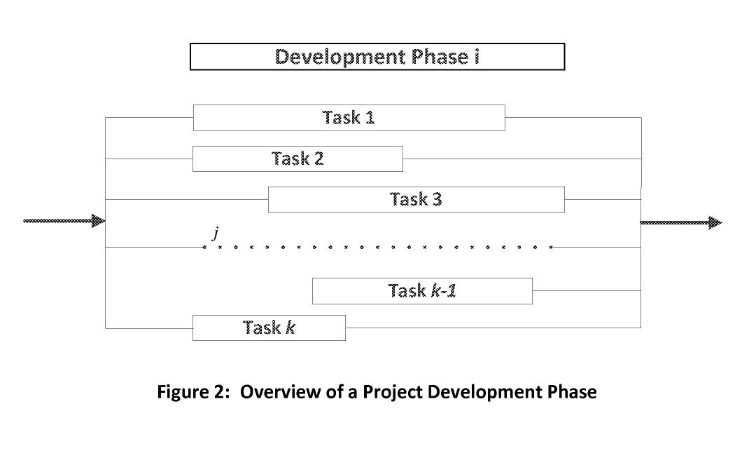

As shown in FIG. 2, each task has a scheduled time (Tⱼ) and a phase deadline (Tᵢ). If the time necessary to complete a task exceeds the scheduled time (Tⱼ), the probability of the task being completed before the phase deadline (Tᵢ) decreases exponentially. This relationship can be expressed as follows:

R^{j}(t)=e^{-λ×t} (3)
Formula 3: Exponential distribution for predicting project reliability on the task level
   Where j: Development task (j=1, k)
      k: Number of tasks within phase i
      R^{j}: Reliability of task j
      λ: Coefficient determined by a specific project

t=T−Tⱼ(0≦t≦Tᵢ−Tⱼ)
T: Actual time
Tᵢ: Deadline for phase i
Tⱼ: Schedule time for task j

If a task has passed the scheduled time (Tⱼ), the probability of the task not being completed (risk) before the phase deadline (Tᵢ) increases exponentially. This relationship can be expressed as follows:

r^{j}(t)=1−Rⱼ(t)=1−e^{-λ×t} (4)
Formula 4: Exponential distribution for predicting project risk on the task level

The above methods describe how to predict project reliability and risk at the task level. The following describes a method for predicting project reliability and risk at the phase level.

As shown in FIG. 2, a development phase i may consists of a number k of independent tasks. The reliability, i.e., the probability of the phase i being completed before the phase deadline, is calculated by:

$$\begin{matrix}Formula 5 \text{:} Project reliability prediction on the phase level & \\ {R}_{i} = {\prod }_{j = 1}^{k} {R}^{j} & ( 5 )\end{matrix}$$

j: Development task (j=1, k)
k: Number of tasks within phase i
R^{j}: Reliability of task j
Rᵢ: Reliability of phase i

The risk, i.e., the probability of the phase i not being completed (risk) before the phase deadline is calculated by:

$$\begin{matrix}Formula 6 \text{:} Project risk prediction on the phase level & \\ {r}_{i} = 1 - {R}_{i} = 1 - {\prod }_{j = 1}^{k} {R}^{j} & ( 6 )\end{matrix}$$

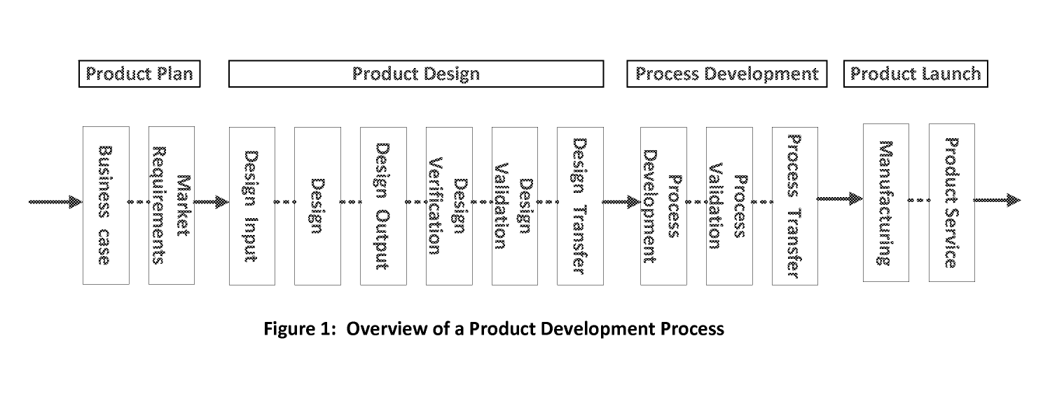

Risk and reliability can be predicted on the project level as follows. As shown in FIG. 1, a new project development process consists of k phases (e.g., thirteen). The reliability, i.e., the probability of the project being completed before project due date, is calculated by:

$$\begin{matrix}Formula 7 \text{:} Project reliability prediction on the project level & \\ {R}_{Project} = {\prod }_{i = 1}^{k} {R}_{i} & ( 7 )\end{matrix}$$

i: Development phase (i=1, k)
k: Number of development phase (default 13)
Rᵢ: Reliability of phase i
R_{Project}: Reliability of entire new product development

The risk, i.e., the probability of the project not completed (risk) before due date, is calculated by:

$$\begin{matrix}Formula 8 \text{:} Project risk prediction on the project level & \\ {r}_{Project} = 1 - {R}_{Project} = 1 - {\prod }_{i = 1}^{k} {R}_{i} & ( 8 )\end{matrix}$$

An exponential distribution can also be used to predict project variation, such as project delay days, budget overages, and part delay days, at the task level, phase level, and project level.

At the project task level, project variation can be predicted by using an exponential distribution. For example, if a task j has not been completed by the scheduled time (Tⱼ), the probability of the task being completed at the point of the phase deadline (Tᵢ) can be calculated by:

$$\begin{matrix}Formula 9 \text{:} Project variation prediction on task level & \\ {D}^{j} = \frac{{T}_{j}}{8} {e}^{- λ \times ( {T}_{i} - {T}_{j} + 1 )} & ( 9 )\end{matrix}$$

Tⱼ: Scheduled time for task j
Tᵢ: Phase deadline
λ: Coefficient determined by a specific project

At the project phase level, if a phase i consists of n tasks, the worst case for the phase variation is calculated by adding the delayed variations of tasks together as:

$$\begin{matrix}Formula 10 \text{:} Project variation prediction on the phase level & \\ {D}_{i} = {\sum }_{j = 1}^{n} {D}^{j} & ( 10 )\end{matrix}$$

D^{j}: Delayed variations on task j
Dᵢ: Delayed variations on phase i

On the project level, if a project consists of k phases, the worst case for the project variation is calculated by adding the delayed variations of phases together as:

$$\begin{matrix}Formula 11 \text{:} Project variation prediction on the project level & \\ {D}_{project} = {\sum }_{i = 1}^{k} {D}_{i} & ( 11 )\end{matrix}$$

Dᵢ: Delayed variations on phase i

During the project planning phase, a project manager may estimate a cycle time for an individual project report based on previous experience and/or feedback from report owners. Project schedule risk is caused by uncertainty or variation in these estimations. The following is a method for predicting project schedule reliability and/or risk and project delays at the levels of reports, phases, and final project.

To predict project schedule reliability and risk, the term “project task” is replaced by “project report”. Project schedule reliability on a report level can be predicted using Formula 3, above. Project schedule risk on a report level can be predicted using Formula 4, above. Project schedule reliability on a phase level can be predicted using Formula 5, above. Project schedule risk on a phase level can be predicted using Formula 6, above. Project schedule reliability on a final project level can be predicted using the Formula 7. Project schedule risk on final project level can be predicted using Formula 8, above.

The above methodology can also be used to predict project schedule delays. When doing so, the term “project variations” is replaced by “project delays”. Project delays on a report level can be predicted using Formula 9, above. Project delays on a phase level can be predicted using Formula 10, above. Project delays on a final project level can be predicted using Formula 11, above.

During project planning phase, a project manager may estimate project costs based on previous experience and/or feedback from budget owners. Project budget risk is caused by uncertainty or variation in these cost estimations. As discussed below, the above methodology may be used to predict project budget risk and reliability, as well as estimate project budget overages at the levels of tasks, phases, and final project.

To predict budget reliability and risk using the above methodology, the term “project tasks” is replaced by “project costs”, “schedule time” is replaced by “planned budget”, and “phase deadline” is replaced by “phase budget”. Cost items for medical development may include clinical cost, regulatory cost, material cost, travel cost, equipment cost, software cost, overhead cost, etc.

Project budget reliability on a task level can be predicted using Formula 3, above. Project budget risk on a task level can be predicted using Formula 4, above. Project budget reliability on a phase level can be predicted using Formula 5, above. Project budget risk on a phase level can be predicted using Formula 6, above. Project budget reliability on a final project level can be predicted using Formula 7, above. Project budget risk on a final project level can be predicted using Formula 8, above.

To predict budget overages using the above methodology, the term “project variations” is replaced by “project budget overage”. Project budget overages on a task level can be predicted using Formula 9, above. Project budget overages on a phase level can be predicted using Formula 10, above. Project budget overages on a final project level can be predicted using Formula 11, above.

During project planning phase, a project manager may estimate lead times on project parts based on previous experience and/or feedback from suppliers. Project supply chain risk is caused by uncertainty or variation in lead times for ordered parts. The following shows the application of the above methodology for predicting supply chain reliability, supply chain risk, and part delays at the levels of parts and purchase orders.

To predict supply chain risk using the above methodology, the term “project tasks” is replaced by “project parts”, “scheduled time” is replaced by “planned part lead time”, and “phase deadline” is replaced by “production order deadline”.

Project supply chain reliability on a part level can be predicted using Formula 3, above. Project supply chain risk on a part level can be predicted using Formula 4, above. Project supply chain reliability on a production order can be predicted using Formula 5, above. Project supply chain risk on a production order can be predicted using Formula 6, above.

To predict supply chain delays using the above methodology, the term “project variations” is replaced by “part delays”. Supply chain delays on a part level can be predicted using Formula 9, above. Supply chain delays on a production order can be predicted using Formula 10, above.

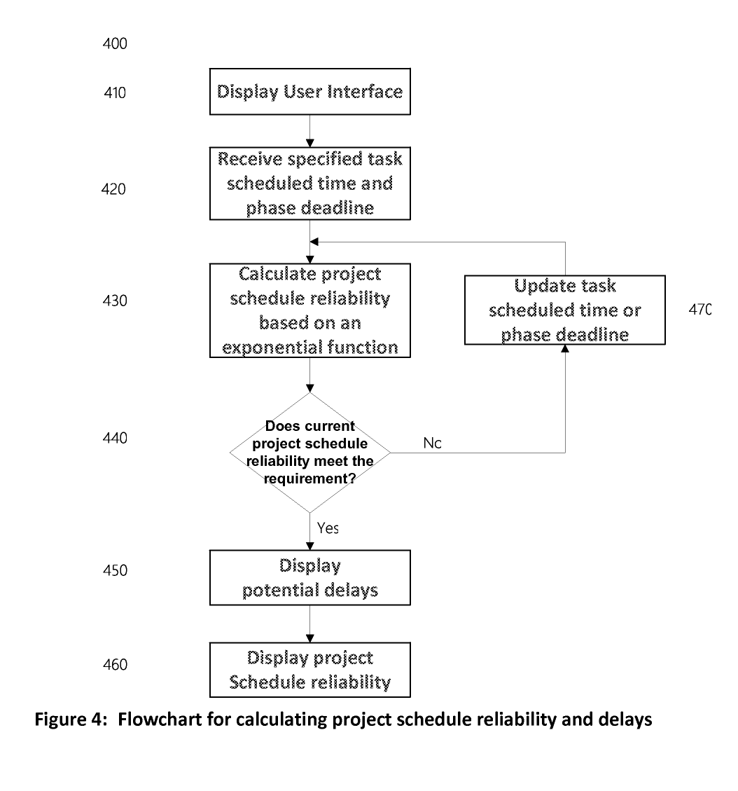

FIG. 4 is a flowchart illustrating method 400 that can be carried out on a computer to calculate project schedule risk in accordance with the disclosure. At step 410, the computer may display a user interface. The user interface may include a field for a task scheduled time and a field for a phase deadline. At step 420, a specified task scheduled time and a specified phase deadline are received via a user interface device and stored in a memory. At step 430, a project schedule reliability value representing a probability of the project task being completed before phase deadline which is calculated based on a function of e^{x}, where e is the natural exponential function and x is the difference of the current time and the task scheduled time. At step 440, it is determined whether chance of the current task completion before phase deadline meet the requirement. If so, display the potential schedule delays at step 450 and the chance of the task completion before phase deadline at step 460 If not, update task scheduled time or phase deadline at step 470, then jump to step 430.

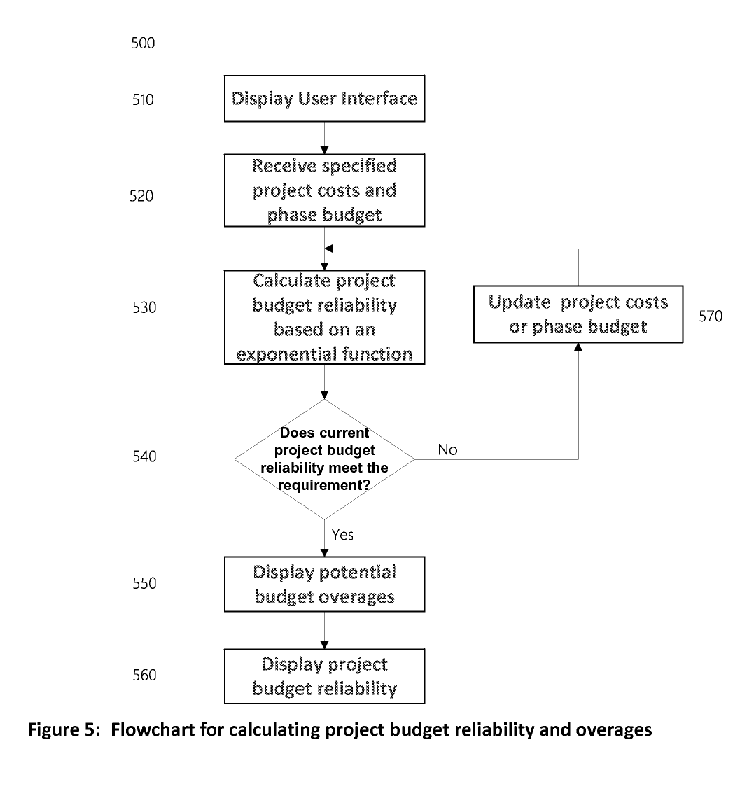

FIG. 5 is a flowchart illustrating method 500 that can be carried out on a computer to calculate project budget risk in accordance with the disclosure. At step 510, the computer may display a user interface. The user interface may include a field for project costs and a field for a project phase budget. At step 520, specified project costs and a specified project phase budget are received via a user interface device and stored in a memory. At step 530, a project reliability value representing a chance of phase completion within budget is calculated based on a function of e^{x}, where e is the natural exponential function and x is the difference of the actual costs and the summary of project costs. At step 540, it is determined whether chance of the current phase completion within budget meet the requirement. If so, display the potential budget overages at step 550 and the chance of phase completion within budget at step 560 If not, update specified project costs or phase budget at step 570, then jump to step 530.

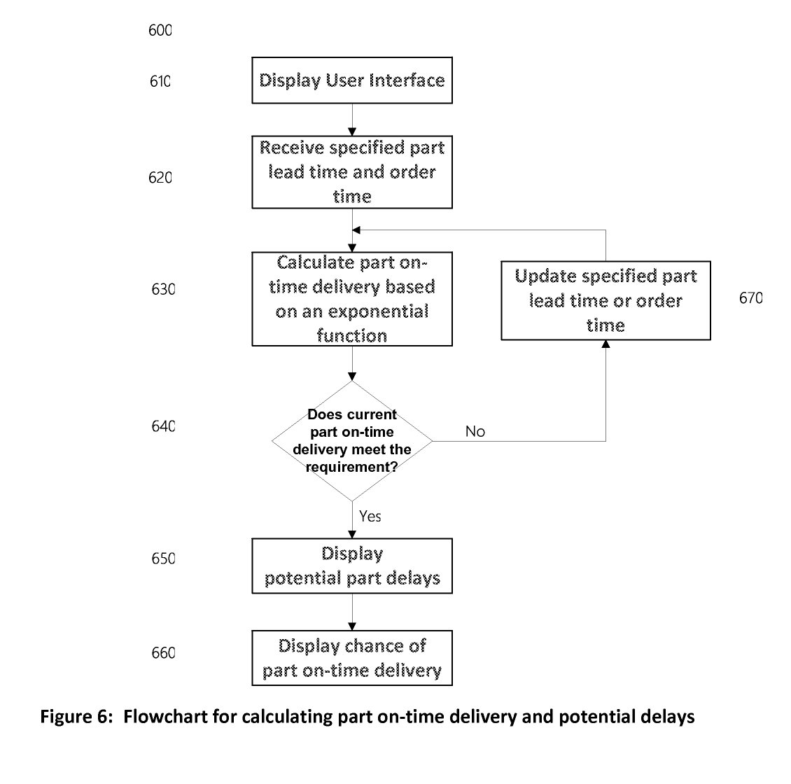

FIG. 6 is a flowchart illustrating method 600 that can be carried out on a computer to calculate project supply chain risk in accordance with the disclosure. At step 610, the computer may display a user interface. The user interface may include a field for a part scheduled lead time and a field for a purchase order time. At step 620, a specified part scheduled lead time and a specified purchase order time are received via a user interface device and stored in a memory. At step 630, a part on-time delivery is calculated based on a function of e^{x}, where e is the natural exponential function and x is the difference of the actual part lead time and the scheduled part lead time. At step 640, it is determined whether the current chance of the part on-time delivery meet the requirement. If so, display the potential part delays at step 650 and the chance of part on-time delivery at step 660 If not, update the specified part lead time or purchase order time at step 670, then jump to step 630.

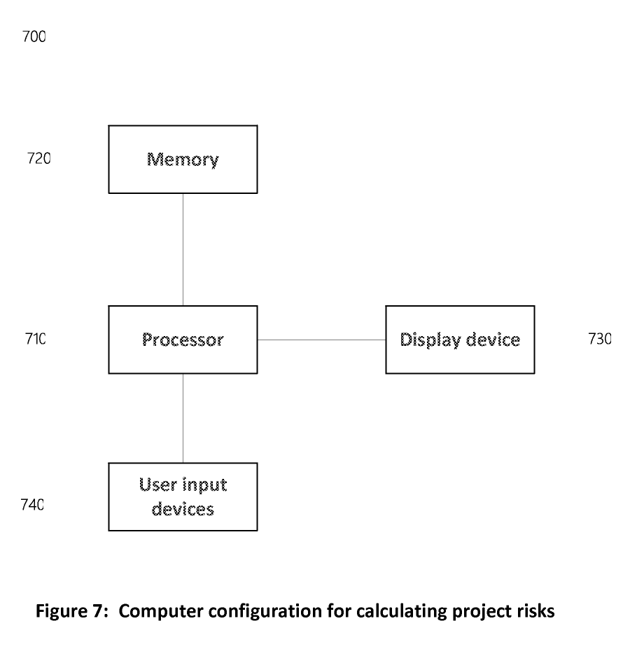

FIG. 7 is an example of a computer configuration 700 that may be used to calculate project risk in accordance with the disclosure. The computer 700 may include a processor 710 coupled to a memory 720, a display device 730, and a user input device 740, such as a keyboard, mouse, etc. A user may operate the user input device 740 to view a user interface of the product development software on the display device 730. The user may provide various inputs to the product development software using the user input device 740. The processor may store user inputs in the memory 720 and display calculated reliability and/or risk statistics to the display device 730.

I claim:

1. A non-transitory computer-readable medium of instructions that, when executed, cause a processor to perform operations for predicting schedule reliability and/or risk in a product development plan, the operations comprising:
displaying a user interface on a display device, the user interface including a field for a project task scheduled time and a field for a project phase deadline;
receiving and storing, via a user input device, a specified project task scheduled time and a specified project phase deadline;
storing a project schedule reliability value representing a probability of the project task being completed before the phase deadline;
updating the stored project schedule reliability value based on a comparison of a current time to the specified task scheduled time, wherein, when the current time is greater than or equal to the specified task scheduled time, the updated reliability value is determined as a function of e^{x}, where e is the natural exponential function and x is proportional to the difference of the current time and the specified task scheduled time; and,
displaying the potential schedule delays and the updated project schedule reliability value in the user interface displayed on the display device.

2. A non-transitory computer-readable medium of instructions that, when executed, cause a processor to perform operations for predicting budget reliability and/or risk in a product development plan, the operations comprising:
displaying a user interface on a display device, the user interface including a field for one or more project costs and a field for a project phase budget;
receiving and storing, via a user input device, one or more specified project costs and a specified project phase budget;
storing a project budget reliability value representing a probability of the project phase being completed within the specified project phase budget;
updating the stored project budget reliability value, wherein the updated reliability value is determined as a function of e^{x}, where e is the natural exponential function and x is proportional to the difference of the sum of the one or more specified project costs and the specified project phase budget; and,
displaying the potential budget overages and the updated project budget reliability value in the user interface displayed on the display device.

3. A non-transitory computer-readable medium of instructions that, when executed, cause a processor to perform operations for predicting supply chain reliability and/or risk in a product development plan, the operations comprising:
displaying a user interface on a display device, the user interface including a field for a part lead time and a field for a part purchase order time;
receiving and storing, via a user input device, a specified part lead time and a specified part purchase order time;
storing a project supply chain reliability value representing a probability of the specified part being delivered within the specified part purchase order time;
updating the stored project supply chain reliability value, wherein the updated reliability value is determined as a function of e^{x}, where e is the natural exponential function and x is proportional to the difference of the actual part lead time and the scheduled part lead time; and,
displaying the potential part delays and the updated project supply chain reliability value in the user interface displayed on the display device.
